(19) United States
(12) Patent Application Publication
(10) Pub. No.: US 2006/0139685 A1
(43) Pub. Date: Jun. 29, 2006

(54) Information-processing apparatus, image-processing method, and computer program

(75) Inventor: Masao Hayashi, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/313,603

(22) Filed: Dec. 20, 2005

(30) Foreign Application Priority Data
Dec. 27, 2004 (JP) 2004-376367

(51) Int. Cl. G06F 3/12

(52) U.S. Cl. 358/1.15

(57) ABSTRACT

The present invention provides an image-processing apparatus that can generate image data from inputted print data, store the generated image data in storage, perform notification about the generation state of the image data, obtain identification information, and output the stored image data based on the obtained identification information. Subsequently, the image-processing apparatus can reduce the time a user spends in waiting in front of a printer until printing is finished.

### BACKGROUND OF THE INVENTION

1. Field of the Invention

The present invention relates to an information-processing apparatus, an image-processing method, and a program that are configured to externally transmit data transmitted from a recording medium and/or an external device.

2. Description of the Related Art

Recently, camera-equipped mobile phones and high-resolution digital cameras have become widely available. Therefore, color-image data is increasingly used by people in their business lives and/or personal lives. Further, standard formats independent of known applications including portable data format (PDF) or the like are increasingly used for generating a business document. Further, printers that can directly print document data without using a personal computer (PC) have become available. Namely, where a mobile memory storing the print data is inserted into the above-described printers, the printers can read and print the document data stored in the mobile memory. Further, the number of shops having a printer that can directly print data on an image photographed by a digital camera is increasing. Since the camera-equipped mobile phones and digital cameras have become widely available, it can be expected that the number of printers that can directly print document data will increase. Further, it can be expected that the number of users that transmit data to a printer installed in a public institution including a convenience store, an airport, a hotel, and so forth, and make the printer print the data will increase.

Japanese Patent Laid-Open No. 2003-44250 discloses the following technology. For printing data stored in a host terminal by using a printer, the address of a predetermined mobile terminal is registered with the host terminal in advance. Further, when printing is finished, the mobile terminal is notified that the printing is finished.

When large-capacity image data such as photograph data is printed, or when a large number of images are printed by using a printer installed in a public institution including an air port, a hotel, a station, a convenience store, and so forth, image rasterization and image processing are performed irrespective of a method by which the printing is achieved, where the method may be a direct printing method performed by using a mobile memory, a method for printing data uploaded to a server, and so forth. Subsequently, a user has to wait for a long time period in front of the printer. Therefore, according to Japanese Patent Laid-Open No. 2003-44250, notification information is transmitted to the mobile terminal after the printing is finished so that the mobile terminal is notified that the printing is finished. Subsequently, the above-described waiting time period is reduced. However, according to the technology proposed by Japanese Patent Laid-Open No. 2003-44250, an outsider may take the printed image. That is to say, Japanese Patent Laid-Open No. 2003-44250 offers no system and/or apparatus configured to reduce the waiting time while retaining security.

### SUMMARY OF THE INVENTION

The present invention provides an image-processing apparatus that can reduce the time a user spends waiting in front of a printer until printing is finished.

According to an aspect of the present invention, an image-processing apparatus includes an input unit configured to transmit print data, a generation unit configured to generate image data from the print data, a storage unit configured to store the image data in storage, a notification unit configured to perform notification about an image-data-generation status of the generation unit, an identification input unit configured to input identification information, and an output unit configured to transmit the stored image data based on the identification information input via the identification input unit.

When print data is transmitted from a recording medium and/or an external device to a printer and the print data is externally transmitted from the printer, the time the user spends waiting in front of a printer until printing is finished can be reduced, i.e., the user can leave the printer.

Further, an ID and/or a Bluetooth address is added to a job and the ID and/or the Bluetooth address is identified at the time when the printer is operated and/or the print data is printed. Subsequently, the print data can be prevented from being changed and/or printed by an outsider and the user can leave the printer without fear of security problems.

The present invention offers new functions. Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a system configuration and a printer according to first and second embodiments of the present invention.

FIG. 2 is an encryption-and-decryption print-management table according to at least one embodiment of the present invention.

FIG. 3 is a print-management table according to the at least one embodiment.

FIG. 4 is a flowchart showing processing procedures according to the first embodiment.

FIGS. 5-12 are examples user interfaces (UIs) of an operation unit according to the at least one embodiment.

FIG. 13 is a flowchart showing processing procedures according to the second embodiment.

FIG. 14 is a block diagram showing a system configuration and a printer according to a third embodiment of the present invention.

FIG. 15 is a flowchart showing processing procedures according to the third embodiment.

FIG. 16 illustrates the state transition of Bluetooth protocols.

### DESCRIPTION OF THE EMBODIMENTS

### First Embodiment

A first embodiment of the present invention will be described in detail next with reference to the attached drawings.

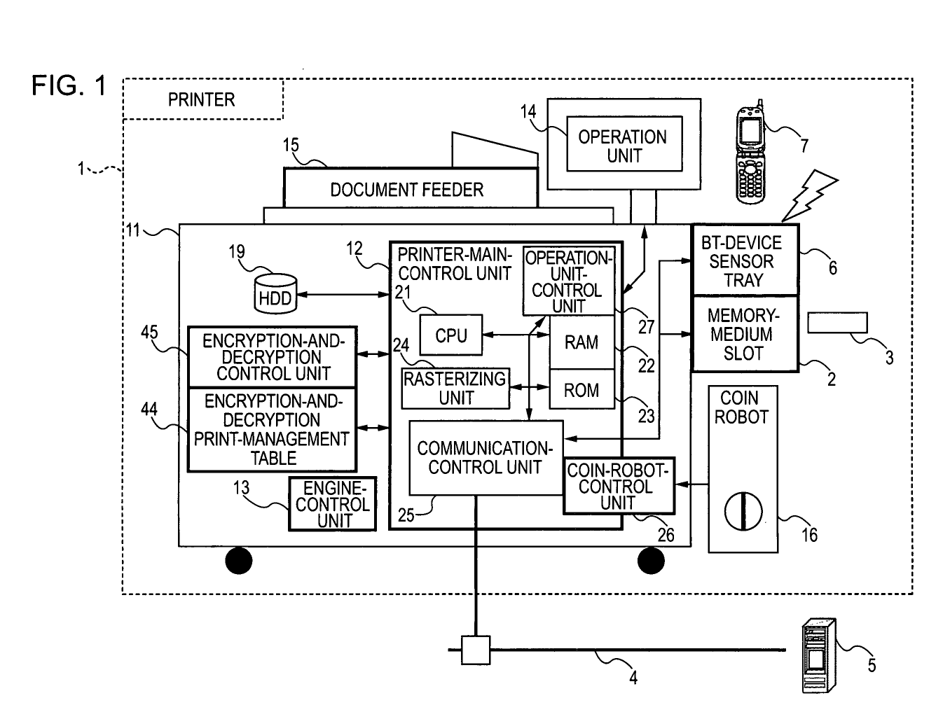

FIG. 1 is a functional block diagram illustrating functions of a printer 1 and the flow of data stored in a recording medium inserted into the printer 1 of the first embodiment.

The printer 1 is installed in a public institution including an airport, a hotel, a station, a convenience store, etc., or an office, for example. The printer 1 is connected to a provider server 5 via a network 4. A user can use “copy service”, “medium-direct-print service”, “network-print service”, and “FAX service” by using the printer 1. If the printer 1 supports “copy service” and “medium-direct-print service” only, the printer 1 may not be connected to the network 4.

Performance of the “medium-direct-print service” is described below. For printing data stored in a recording medium, the recording medium is inserted into the printer 1 via a universal-serial-bus (USB) port or the like so that the data is transferred to the printer 1 and printed. The “network-print service” is performed as described below. The user uploads document data that the user wants to have printed to the provider server 5 in advance, selects the uploaded document data by operating a control panel of the printer 1, and downloads the document data to the printer 1 so that the document data is printed. The above-described service can be referred to as a pull-print service. Further, where the print data is uploaded to the server 5, the server 5 transmits an identification password required for executing print processing to the user in advance.

The first embodiment illustrates the “medium-direct-print service”. A second embodiment of the present invention illustrates the “network-print service”.

A memory-medium slot 2 is provided, as a memory-interface unit of the printer 1. Various types of mobile memory mediums can be inserted into the memory-medium slot 2 so that data stored in the mobile memory mediums can be transmitted to the printer 1. A mobile memory medium 3 is provided, as any one of the above-described mobile memory mediums including a disk medium such as a compact disk-read-only memory (CD-ROM), a digital versatile disk-ROM (DVD-ROM), and so forth, a semiconductor medium such as an secure-digital (SD) card, a compactFlash (CF) card, a personal computer memory card international association (PCMCIA) card, and so forth, a general-purpose interface medium such as a USB memory. The above-described mobile mediums can be inserted into the memory-medium slot 2. Namely, the memory-medium slot 2 functions, as various types of interface units.

A Bluetooth-device sensor tray 6 (hereinafter referred to as a BT-device-sensor tray 6) is connected to the printer 1, so as to detect a Bluetooth-I/F-mounting device and to receive the Bluetooth-device address (hereinafter referred to as a BTD address) thereof.

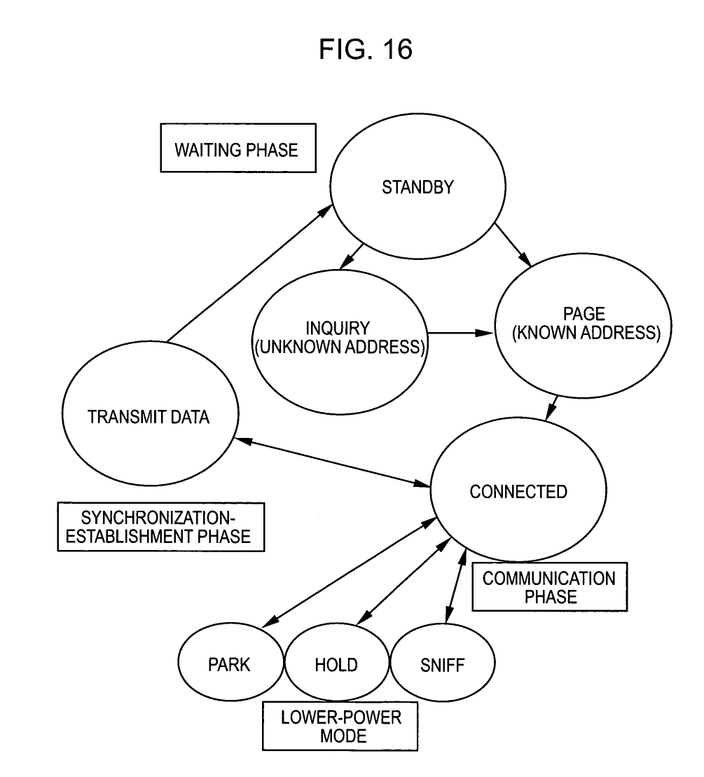

FIG. 16 illustrates the state transitions of Bluetooth protocols. The term “STANDBY” denotes the waiting phase. Where there is not any other BT device in the Piconet area (an area about ten meters in radius) of the user's BT device, the state of the Bluetooth protocols is shifted to the connection-waiting state.

The term “INQUIRY” denotes the inquiry phase. Where another BT device is identified in the Piconet area, it is determined whether or not the BT device is connected for the first time, and the profile of the BT device is read. Subsequently, it is determined what type of device the BT device is. For example, the BT device may be a printer, a mobile phone, or a camera.

The term “PAGE” denotes the calling phase in which the Bluetooth-device address unique to each of the BT devices acquires connection to a known BT device. The term “CONNECTED” is the connection phase in which the Bluetooth-device address is connected to the BT device in the Piconet area. The term “TRANSMIT DATA” denotes the synchronization-establishment phase in which data is actually transmitted and/or received between the BT devices. Thus, in the Bluetooth system, the BT device can communicate with another BT device connected thereto for the first time. Further, data can be transmitted and/or received at a high speed between known BT devices.

The BT-device-sensor tray 6 has a sensor function so as to detect a predetermined BT device placed thereon. Further, the BT-device-sensor tray 6 can determine a BT device communicating with the printer 1 so as to establish the Bluetooth-communication session only when a predetermined device is placed on the BT-device-sensor tray 6. Further, if the assumption is made that the BTD address of a predetermined BT device is registered with the printer 1, where the BT device exists within a ten-meter radius of the BT-device-sensor tray 6 of the printer 1 (a Piconet-supportable area), the printer 1 transmits a message (printing preparations are completed, an error occurs, and so forth) to the BT device via a Bluetooth interface (I/F). Further, an area less than one point seven meters in radius of the BT-device-sensor tray 6 is determined to be a proximity-identification area. The BT-device-sensor tray 6 can determine whether or not another BT device exists in the proximity-identification area.

The printer 1 includes a printer main body 11, the memory-medium slot 2, the BT-device-sensor tray 6, and a coin charge apparatus 16. The printer main body 11 performs the print function and the coin charge apparatus 16 performs the charge function of the printer 1. The printer main body 11 includes a main control unit 12, an engine-control unit 13, an operation unit 14, a document feeder (DF) 15, a coin charge apparatus-control unit 26, an encryption-and-decryption control unit 45, an encryption-and-decryption print-management table 44, and a hard disk drive (HDD) 19.

The main control unit 12 includes a rasterizing unit 24 configured to generate print data transmitted to a central processing unit (CPU) 21, a random access memory (RAM) 22, a read-only memory (ROM) 23, and the engine-control unit 13. Further, the main control unit 12 includes a communication-control unit 25 configured to transmit and/or receive information to/from an external device via a network and receive image data transmitted from a scanner, and an operation-unit-control unit 27 configured to transmit and/or receive information to/from the operation unit 14. The CPU 21 performs various types of control based on at least one program stored in the ROM 23. The engine-control unit 13 controls the print execution. The operation unit 14 is a user interface (UI) configured to transmit various types of commands and data, and includes a display unit such as a liquid-crystal display (LCD) and an input device including a hard key, a touch panel, and so forth. The DF 15 reads data corresponding to a document including at least two pages at a time. The coin charge apparatus-control unit 26 functions, as an interface between the coin charge apparatus 16 and the main-control unit 12 and calculates the use fee according to the number of prints and/or the quality of image. Further, the encryption-and-decryption control unit 45 performs data encryption and/or data decryption when print data that had been subjected to raster image processing (RIP) is stored and/or read in/from the HDD 19 and/or the RAM 22. The encryption-and-decryption print-management table 44 stores the BTD address that is transmitted from the BT-device-sensor tray 6 and that is unique to the Bluetooth I/F mounting device 7 (hereinafter referred to as the BT device 7) in the unit of print job, as an encryption-and-decryption key functioning as key information for performing the data encryption and/or data decryption. The rasterizing unit 24 performs the above-described RIP. Namely, pixel-unit print data (image data) or image data that can be printed at any time is generated from the transmitted print data and stored in the HDD 19. Further, the BT device 7 is placed on the BT-device-sensor tray 6 and the BTD address unique to the BT device 7 is read therefrom. The encryption-and-decryption print-management table 44 is a table storing the read BTD address in relation to the print data, as a secure-identification code of the print data transmitted from the memory-medium slot 2.

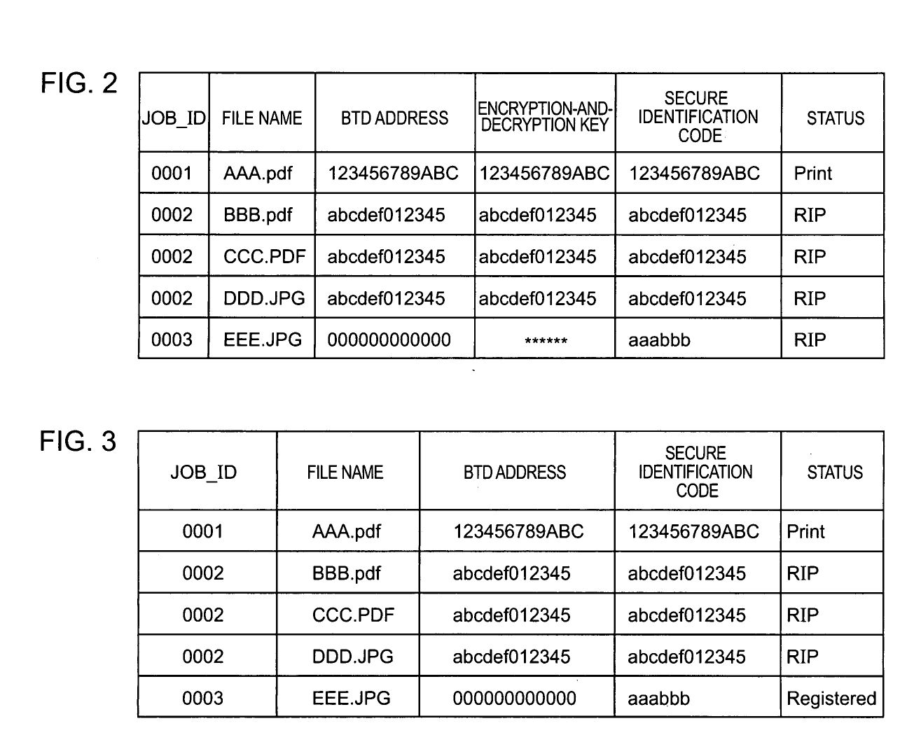

FIG. 2 shows the encryption-and-decryption print-management table 44 storing JOB_IDs, file names, BTD addresses, encryption-and-decryption keys, and secure-identification codes. Further, data items about the current processing status are also stored in the table 44 in sequence. The JOB_ID denotes the charge unit defined for each user. Each of the encryption-and-decryption key and the secure-identification code is added to the JOB_ID on a one-to-one basis. Where encryption or decryption is not performed for a print job, the encryption-and-decryption print-management table 44 does not store any encryption-and-decryption key, as shown in FIG. 3. The HDD 19 is large-capacity storage that can store a large quantity of print data and/or scan data, and print data that has been subjected to the RIP.

Next, example medium-direct printing performed by the printer 1 of the first embodiment will be described with reference to FIG. 1.

1. A user brings print data including image data and/or text data stored in the mobile memory medium 3 to a convenience store or the like, to print the print data.

2. The user inserts the mobile memory medium 3 into the memory-medium slot 2, selects the print data according to the UI of the operation unit 14, and makes settings on the number, resolution, and so forth of prints for the print data.

3. A message is generated and shown on the operation unit 14 so that the user can determine whether or not to leave the printer 1 during the performance of the print processing. Where the user determines that the user does not leave the printer 1 during the print processing is performed, the print processing is executed.

4. Where the user determines that the user leaves the printer 1, a message is shown on the operation unit 14, so as to instruct the user to place the BT device 7 on the BT-device-sensor tray 6, if the user had any BT device 7 including a mobile phone, a digital camera, head phones, a PDA, and so forth. Where the BTD address of the BT device 7 is transmitted, a message is shown on the operation unit 14, so as to inform the user that the user may leave the printer 1 until print preparations are made. If the user does not have any BT device 7, the printer 1 generates an identification password for the print data and shows the identification password on the operation unit 14. When RIP is finished, the user transmits the identification password via the operation unit 14, and printing is performed.

5. The printer 1 generates the pixel-unit print data (image data) including image data that can be printed at any time from the transmitted print data, encrypts the pixel-unit print data by using the BTD address, as an encryption key, and stores the encrypted pixel-unit print data in the HDD 19 and/or the RAM 22. When the print preparations are made, the printer 1 informs the user's BT device 7 having the display function that the print preparations are made by using the Bluetooth system. In that case, the BT device 7 may be a mobile phone, a PDA, and so forth.

6. When the user stands in front of the printer 1 again and places the BT device 7 on the BT-device-sensor tray 6, the printer 1 performs identification, so as to check the BTD address of the BT device against the BTD address registered with the printer 1. When the identification is finished, the encryption-and-decryption-control unit 45 decrypts the encrypted pixel-unit print data stored in the HDD 19 and/or the RAM 22 by using the BTD address of the BT device 7, as a decryption key. Where the decryption is finished, charge information is shown on the operation unit 14. Further, it is confirmed that money is paid, and printing is executed.

The processing performed by the printer 1 from when data is acquired from the memory medium to when the data is printed will be described in detail with reference to FIGS. 1, 2, 4, 5, 6, 7, 8, 9, 10, 11, and 12. The components designated by reference numerals are the same as those shown in FIG. 1.

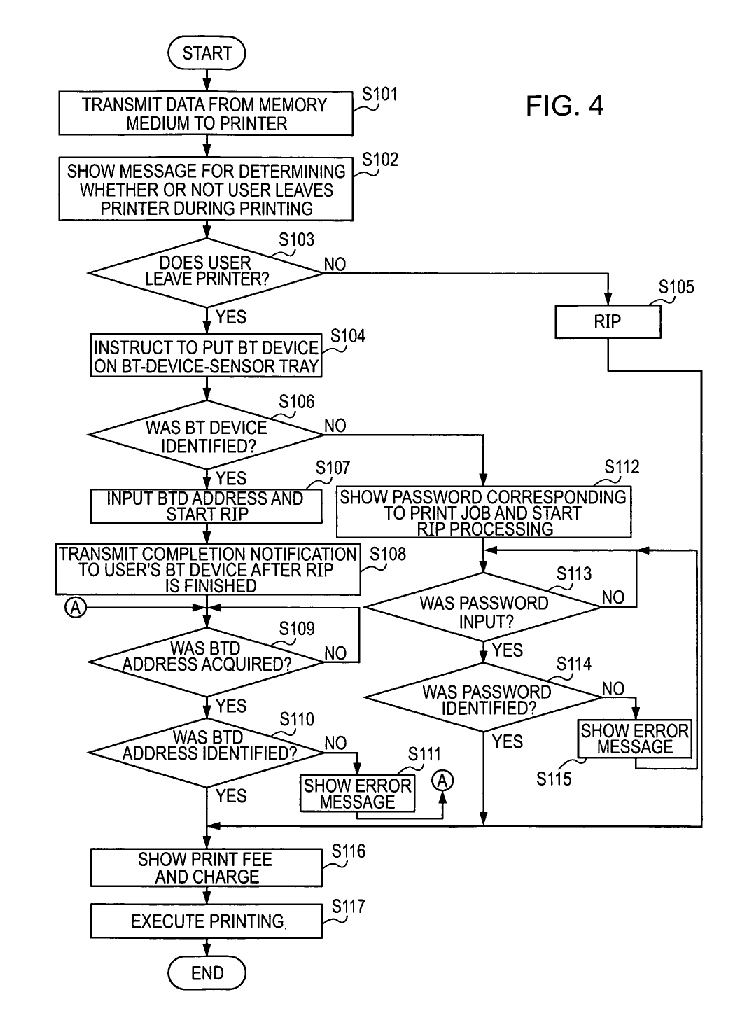

FIG. 4 is a flowchart illustrating operations performed by the printer 1, so as to print data acquired from the memory medium. The CPU 21 of the main-control unit 12 executes various programs stored in the HDD 19 and/or the ROM 23, to perform the operations shown in FIG. 4.

First, at step S101, the user selects “medium-direct-print service” from among messages shown on the operation unit 14, inserts the memory medium 3 that includes print data that was brought by the user into the memory-medium slot 2. Print data is then provided to the printer 1. The print data stored in the memory medium 3 may be transmitted to the printer 1. The printer 1 may be directly connected to a predetermined personal computer (PC) via a USB cable or the like, so that print data stored in a ROM or a hard disk of the PC is transmitted to the printer 1. The printer 1 may be directly connected to a digital camera via a cable so that print data stored in a memory of the digital camera is transmitted to the printer 1. Further, the printer 1 may be connected to another information device via a cable or the like so that data stored in the information device is directly transmitted to the printer 1. Next, the user performs an operation according to the UI of the operation unit 14 to select desired print data from the print data transmitted to the printer 1 and to set the number and resolution of prints that are to be made of the print data.

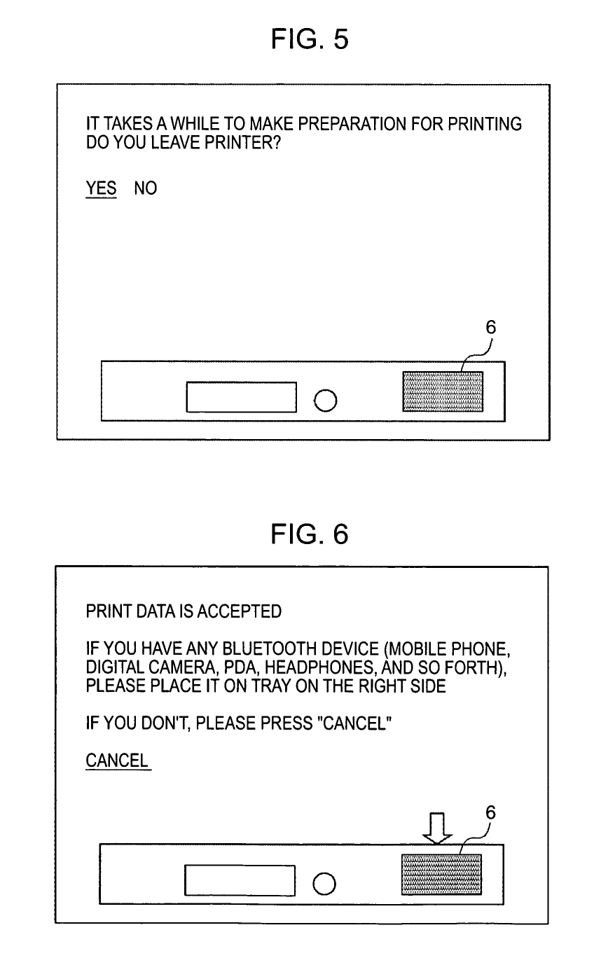

Next, at step S102, a message for confirming whether or not the user leaves the printer 1 while printing is being performed is shown on the operation unit 14. FIG. 5 shows an example screen image displayed on the operation unit 14, so as to show the above-described message. In FIG. 5, reference numeral 6 denotes the BT-device-sensor tray 6. Where the number of prints is small, the above-described message may not be shown. Subsequently, the first embodiment can respond to either the demand of a user who wants to make effective use of a time period while printing is being performed or that of a user who can wait over the time period while the printing is being performed.

At step S103, it is selected whether or not the user leaves the printer 1 while the printing is being performed. When it is selected that the user does not leave the printer 1, the flow proceeds to step S105 where the rasterizing unit 24 performs RIP. Processing then proceeds to step S116. When it is selected that the user leaves the printer 1 while the printing if being performed, the flow proceeds to step S104 where the power of the user's BT device 7 (any BT device including a mobile phone, a digital camera, a personal digital assistant (PDA), headphones, and so forth) is turned on, and a message is shown on the UI of the operation unit 14, so as to instruct the user to place the BT device 7 on the BT-device-sensor tray 6. FIG. 6 shows an example screen image displayed on the operation unit 14, at step S104. In FIG. 6, reference numeral 6 denotes the BT-device-sensor tray 6.

At step S106, the BT device 7 is identified by a sensor provided in the BT-device-sensor tray 6. If the BT device 7 is identified, the flow proceeds to step S107. If the BT device 7 is not identified, or the message “cancel” shown in FIG. 6 is selected, the flow proceeds to step S112.

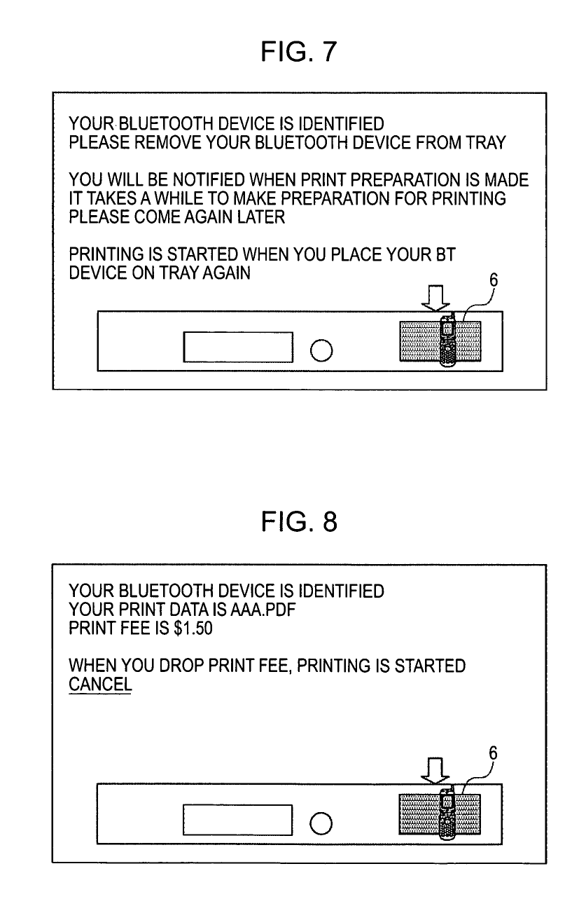

When the flow proceeds to step S107, that is to say, when the user's BT device 7 placed on the BT-device-sensor tray 6 is identified, an example screen image is shown on the UI of the operation unit 14, as shown in FIG. 7. Then, the BTD address unique to the BT device 7 is read and registered with the encryption-and-decryption print-management table 44 of the printer 1 in relation to the print data, as the secure-identification code of the print data. For example, each of JOB_ID 0001 and JOB_ID 0002 that are shown in FIG. 2 corresponds to the encryption-and-decryption print-management table 44, where the BTD address is generated.

Where the user makes the printer 1 read the BTD address, the BTD address functions, as an encryption-and-decryption key which is a key parameter used for encryption and the pixel-unit-print data is encrypted. The encrypted pixel-unit-print data is stored in the HDD 19 and/or the RAM 22. Further, the BTD address functions, as the secure-identification code, so as to permit print execution.

Further, the main-control unit 12 can determine what kind of device the BT device 7 is, based on profile information stored in the device (BT-device identification-and-determination processing). If the BT device 7 is a PDA, or a mobile phone that can receive a message based on the Bluetooth system, the main-control unit 12 makes the operation unit 14 produce the message “You will be notified when print preparation is made”, for the BT device 7 when the RIP is finished. Further, when the BT device 7 is headphones or a digital camera that does not receive a message based on the Bluetooth system, a predetermined time period is required for performing the RIP. In that case, the main-control unit 12 makes the operation unit 14 produce a predetermined message, so as to instruct the user to wait for the predetermined amount of time and come to the printer 1 again. After that, a display image produced on the operation unit 14 is changed, so as to show that the printer 1 is ready to start printing and receive a print instruction transmitted from the next user. Then, in the printer 1, the rasterizing unit 24 starts performing RIP for print data transmitted from the previous user. Further, while the RIP is being performed, the next user cannot change the print settings made by the previous user, as long as the BTD address of the previous user is not identified.

When the RIP is finished, at step S108, the Bluetooth communications are performed between the printer 1 and the BT device 7 and the message “RIP is finished and printing can be performed” is shown on the display unit of the BT device 7. Further, the message “RIP will be finished soon” or the generation status of an image (image data) ready to be printed may be shown on the display unit of the BT device 7 immediately before the RIP is finished. However, when the BT device 7 does not receive a Bluetooth message, the above-described messages are not shown on the display unit of the BT device 7. Further, the mail address of the BT device 7 may be acquired from the profile information stored in the device, which is obtained through the BT-device identification-and-determination processing, and transmitted to the BT device 7 by electronic mail. Further, when the RIP is finished, pixel-unit print data (image data) generated by the RIP is encrypted by using the BTD address functioning as an encryption-and-decryption key, and stored in the HDD 19 and/or the RAM 22.

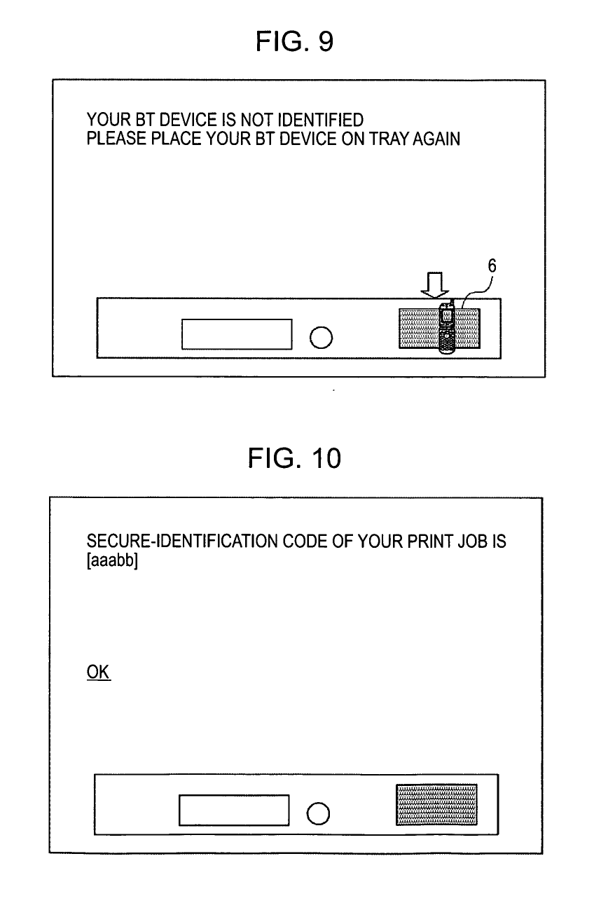

Next, at step S109, the user places the BT device 7 on the BT-device-sensor tray 6 again. When the BTD address of the BTD device 7 is acquired, the flow then proceeds to step S110. Otherwise, the processing corresponding to step S109 is repeated until the BTD address is acquired. When the BTD address is identified, at step S110, the flow proceeds to step S116 where the pixel-unit-print data (image data) that had been subjected to the RIP is specified and the pixel-unit-print data that is encrypted and stored in the HDD 19 and/or the RAM 22 is decrypted by using the secure-identification code of the pixel-unit-print data, as a decryption key. When the pixel-unit-print data (image data) is decrypted, the charge information of print data selected by the user is calculated by the coin charge apparatus-control unit 26. Then, the charge information is shown on the UI of the operation unit 14, as shown in FIG. 8. Next, when the use fee is paid through the coin charge apparatus 16 according to the above-described charge information, a charge is made. Subsequently, the flow proceeds to step S117 where printing is performed.

Where the BTD address is not identified, at step S110, the flow proceeds to step S111 where an error message, such as “Your BT device is not identified. Please place your BT device on tray again.” is shown on the UI of the operation unit 14, as shown in FIG. 9. Where the RIP is not finished, a message such as “RIP is not yet finished. Please print after a while.” is shown on the UI of the operation unit 14, at step S111. Further, the identification information transmitted, at step S110 may not be the identification information of the BT device identified, at step S106, as long as the print data can be determined. For example, identification information may be added to the print data and transmitted, at step S101, so as to be transmitted, at step S110. Further, the BTD addresses of at least two BT devices may be transmitted, at step S106, so that the BTD address of one of the BT devices is transmitted, at step S110. After an error message such as the one shown in FIG. 9 is displayed at step S111, processing returns to step S109 to retry acquisition of the BTD address. In exemplary embodiments, after a predetermined number of attempts to identify the BT device, processing ends.

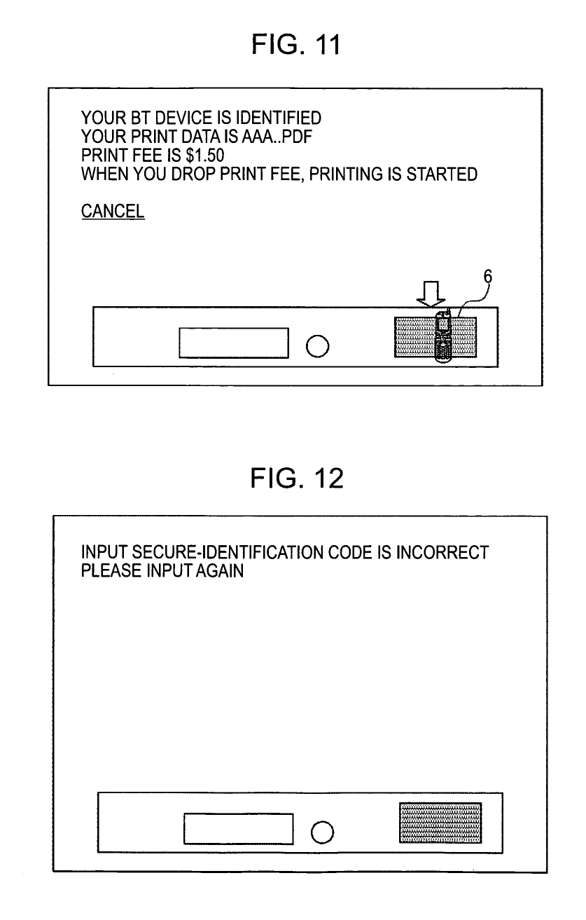

At step S112, the printer 1 generates the secure-identification code corresponding to the print job selected by the user, at step S101, and the secure-identification code is shown on the operation unit 14, as shown in FIG. 10. Then, the rasterizing unit 24 performs RIP. At that time, the secure-identification code is registered with the encryption-and-decryption print management table 44 in relation to the print job. Data that had been subjected to the RIP is encrypted by using the secure-identification code and stored in the HDD 19 and/or the RAM 22. Further, since the secure-identification code should be transmitted for performing printing, the user should remember the secure-identification code by writing it down, for example. In FIG. 3, the secure-identification code corresponding to JOB_ID 0003 is shown, as “aaabbb”. Since Bluetooth communications are not performed, the BTD address is shown, as “0000”. Next, at step S113, the user returns to the printer 1 after a while. When the secure-identification code is transmitted, the flow proceeds to step S114. Otherwise, the processing corresponding to step S113 is repeated until the secure-identification code is transmitted. When the secure-identification code is identified, at step S114, the flow proceeds to step S116 where the pixel-unit print data that is encrypted and stored in the HDD 19 and/or the RAM 22 is decrypted by using the secure-identification code of the pixel-unit print data, as a decryption key. After the pixel-unit print data (image data) is decrypted, the coin charge apparatus-control unit 26 calculates the charge information of print data selected by the user. Then, the charge information is shown on the UI of the operation unit 14, as shown in FIG. 11. Next, when the use fee is paid through the coin charge apparatus 16 according to the above-described charge information, a charge is made. Subsequently, the flow proceeds to step S117 where printing is performed.

When the secure-identification code is not identified, at step S114, the flow proceeds to step S115 where a message such as “Input secure-identification code is incorrect.” is shown on the UI of the operation unit 14, as shown in FIG. 12. Further, when the RIP is not finished, the message “RIP is not yet finished. Please input data again after a while.” is shown on the UI of the operation unit 14, at step S115. After the error message such as the one shown in FIG. 12 is displayed, processing returns to step S113 and the user can re-enter the password. In exemplary embodiments, if the user does not enter the correct password after a predetermined number of attempts, processing ends.

When the user wants to operate the printer 1 while the RIP is being performed, the identification processing corresponding to step S109 and/or step S113 can be performed while the RIP is being performed. After the identification is made, various operations including print-cancellation processing, print-number change processing, print-resolution change processing, etc. can be performed.

Thus, according to the first embodiment, image data subjected to RIP by using the secure-identification code corresponding to a print job and/or a BTD address unique to the device corresponding to the print job is encrypted in the printer 1. Further, print-setting change and/or printing of the image data subjected to the RIP is not permitted until identification is made by using the secure-identification code and/or the BTD address unique to the device. As a result, it becomes possible to prevent the print data and/or the print settings from being changed by an outsider even though the user leaves the printer 1 while the RIP is being performed. Further, it becomes possible to prevent the image data that had been subjected to the RIP from being output by a person other than the user who made a request to execute printing. Further, since the user is informed that the RIP is finished via a communication unit and/or a communication system including a BT device, electronic mail, and so forth, not only the security of the print data can be retained but also the user can leave the printer 1 without fear of security. Subsequently, the user can make effective use of the print-waiting time.

Further, after the user transmits print-JOB information about a print JOB to the printer 1, the user is informed that the user may leave the printer. Subsequently, the next user can immediately transmit the next print-JOB information to the printer 1, so that the use efficiency of the printer 1 increases.

Further, since a mobile device having the Bluetooth function uses the BTD address thereof, as a secure-identification code, the mobile device can communicate with the printer 1 without registering data on the mobile device with the printer 1 in advance. Therefore, when the user carries the mobile device having the Bluetooth function with him, the user does not have to write down and/or remember a password. Further, the user can easily leave the printer 1 while printing is being performed. Therefore, it can be expected that the number of user, particularly, young users and elderly users, will increase.

### Second Embodiment

Next, the second embodiment of the present invention will be described in detail with reference to the attached drawings. In the first embodiment, the recording medium is inserted into the printer 1 and data stored in the recording medium is identified by using the secure-identification code and/or the BTD address and printed.

However, the second embodiment relates to the “network-print service” wherein the user uploads print data to the server 5 in advance, selects the uploaded print data from the operation unit 14 of the printer 1, and downloads the selected data to the printer 1. Then, the downloaded data is identified by using a secure-identification code and/or a BTD address and printed, as is the case with the first embodiment.

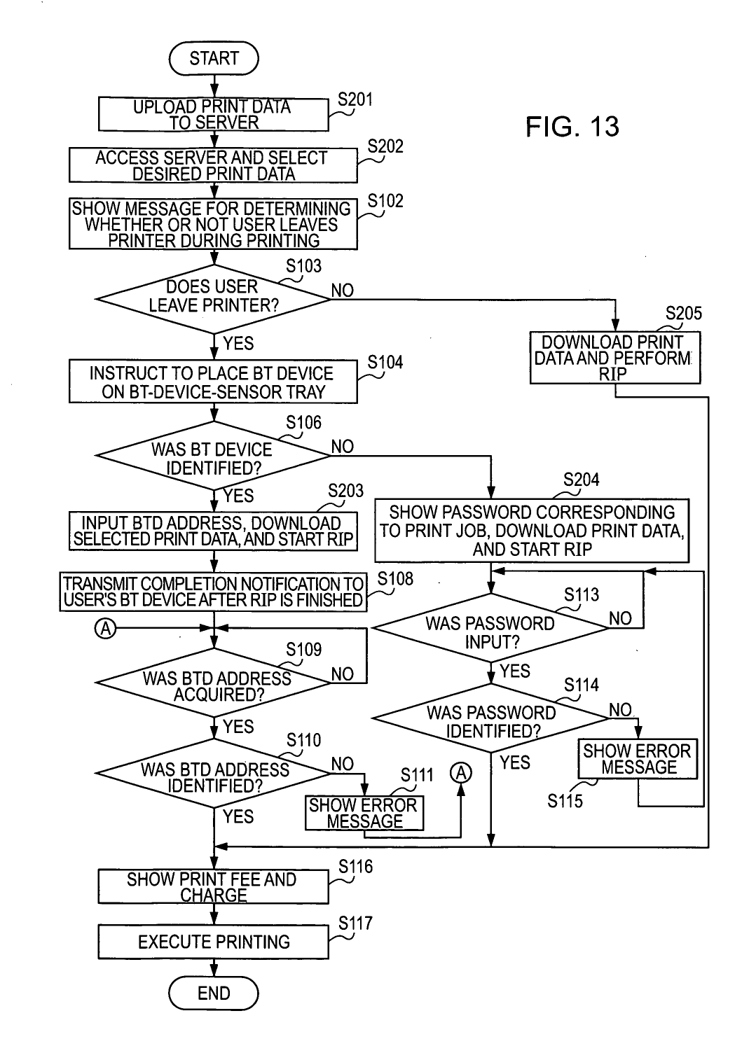

FIG. 13 shows the flow of processing performed by the printer 1 from when data that was uploaded to a server in advance is acquired to when the acquired data is printed. Steps S102, S103, S104, and S106, steps S108, S109, S110, and S111, and steps S113, S114, S115, S116, and S117 shown in FIG. 13 will not be described below, since the above-described steps are the same as those described in the first embodiment. Therefore, only steps S201, S202, S203, S204, and S205 will be described below.

At step S201, image data and/or document data that the user wants to have printed is uploaded to the provider server 5 from a PC, a mobile-information device, and so forth in advance. Where the print data is uploaded, an identification password used for performing printing is downloaded from the provider server 5 to the printer 1, and the identification password is shown on the operation unit 14.

At step S202, the user comes to a convenience store or the like, so as to print the data that was uploaded to the provider server 5, and transmits the identification password that was transmitted to the printer 1, at step S201, from the operation unit 14 of the printer 1 installed in the convenience store, and identification is performed. When the identification is finished, a desired image is selected and settings on the number and resolution of prints are made.

After the user's BT device 7 is placed on the BT-device-sensor tray 6 and identified, a screen image such as the one shown in FIG. 7 is displayed on the UI of the operation unit 14 and the BTD address unique to the BT device 7 is read, at step S203. Further, the main-control unit 12 can determine what type of device the BT device 7 is, based on profile information stored in the device (BT-device identification-and-determination processing). If the BT device 7 is a PDA or a mobile phone that can receive a message based on the Bluetooth system, the main-control unit 12 makes the operation unit 14 display a message such as “You will be notified when print preparation is made” for the BT device 7 when the RIP is finished. Further, when the BT device 7 is headphones or a digital camera that cannot receive a message based on the Bluetooth system, which means that a predetermined time period is required for performing the RIP, the main-control unit 12 shows a predetermined message on the operation unit 14, so as to instruct the user to wait for a while and come to the printer 1 again. After that, a display image shown on the operation unit 14 is changed, so as to show that the printer 1 is ready to start printing and receive a print instruction transmitted from the next user. Then, in the printer 1, data selected by the previous user -is downloaded to the main-control unit 12 of the printer 1 and temporarily stored in the RAM 22 and/or the HDD 19. Then, the BTD address and the downloaded data are registered with the encryption-and-decryption print-management table 44 of the printer 1 in relation to each other. Then, the rasterizing unit 24 performs RIP. For example, JOB_ID 0001 and JOB_ID 0002 that are shown in FIG. 2 correspond to a table generated when the BTD address is read. Further, while data is being downloaded and/or RIP is being performed, the next user cannot change the print settings made by the previous user, as long as the data is not identified by using the BTD address of the previous user.

At step S204, the printer 1 generates the secure-identification code corresponding to the print job selected by the user, at step S202, and the secure-identification code is shown on the operation unit 14, as shown in FIG. 10. Then, the selected print data is downloaded to the main-control unit 12 and temporarily stored in the RAM 22 and/or the HDD 19. The rasterizing unit 24 performs RIP for the selected print job. At that time, the secure-identification code is registered with the encryption-and-decryption print-management table 44 in relation to the print job. Data that had been subjected to RIP is encrypted by using the secure-identification code and stored in the HDD 19 and/or the RAM 22. Further, since the secure-identification code should be transmitted for performing printing, the user should remember the secure-identification code by writing it down, for example.

At step S205, the selected print data is downloaded to the main-control unit 12 and the rasterizing unit 24 performs RIP for the downloaded print data.

That is to say, where data that had already been uploaded to the provider server 5 is printed by using the above-described configuration of the second embodiment, the data is transmitted from the provider server 5 to the printer 1 and subjected to RIP by the rasterizing unit 24, such that image data is obtained. The image data is encrypted by using the secure-identification code corresponding to the print job and/or the BTD address unique to the BTD device 7 corresponding to the print job. Further, print-setting change and/or printing of the image data that had been subjected to the RIP is not permitted until identification is made by using the secure-identification code and/or the BTD address. As a result, it becomes possible to prevent the print data and/or the print settings from being changed by an outsider even though the user leaves the printer 1 while RIP is being performed. Further, it becomes possible to prevent the image data that had been subjected to RIP from being printed by a person other than the user who made a request to execute printing.

Further, since the user is informed that the RIP is finished via a communication system including a BT device, electronic mail, and so forth, not only the security of the print data can be retained but also the user can leave the printer 1 without fear of security. Subsequently, the user can make effective use of the print-waiting time.

Further, when the secure-identification code and/or the BTD address is registered with the printer 1, data is downloaded from the provider server 5 and the printer 1 performs RIP. Further, print-setting change and/or printing of the image data that had been subjected to the RIP is not permitted until identification is made by using the secure-identification code and/or the BTD address. Subsequently, it becomes possible to prevent the print data and/or the print settings from being changed by an outsider while desired data is downloaded from the provider server 5 and/or while RIP is being performed. Therefore, the user can leave the printer 1 without fear of security problems.

### Third Embodiment

Next, a third embodiment of the present invention will be described in detail with reference to the attached drawings.

In the first embodiment, the recording medium is inserted into the printer 1 and data stored in the recording medium is identified based on the secure-identification code and/or the BTD address and printed.

According to the third embodiment, a user accesses a Web site on the internet from a Web browser shown on an operation unit of a printer, selects desired print data, performs display and registration of a secure-identification code, and performs registration of identification information including the BTD address or the like of the user's BT device. Then, desired data is downloaded to the printer and RIP is started.

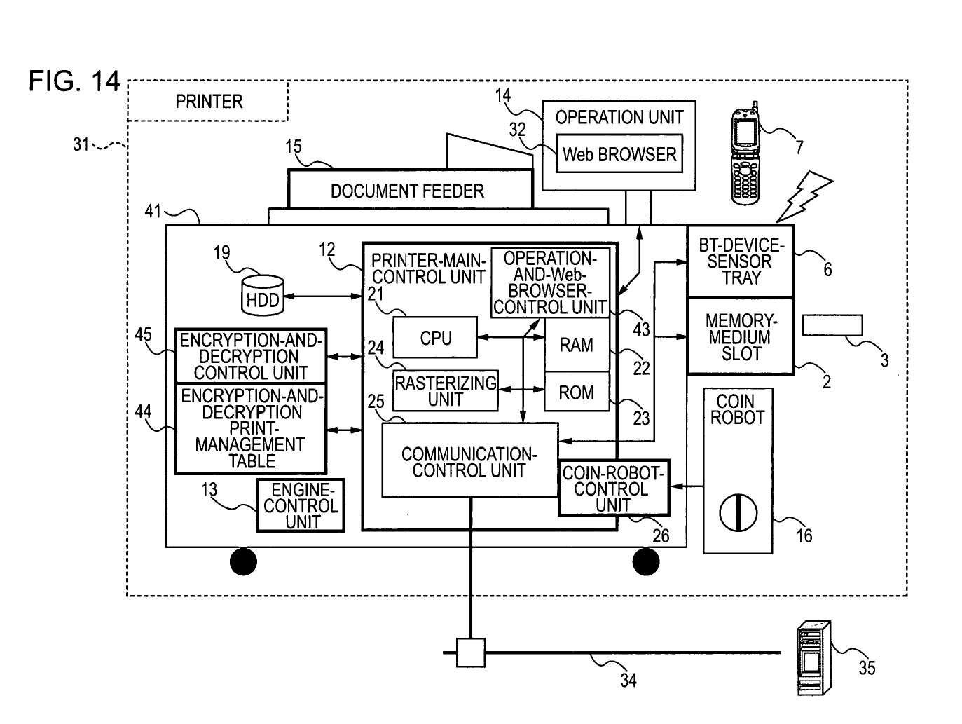

FIG. 14 is a functional block diagram illustrating the flow of data in the case where Web-print service is performed. The Web-print service denotes printing data transmitted from a Web site shown on the operation unit of the printer of the third embodiment. FIG. 14 also illustrates the functions of the printer. In FIG. 14, components having the same functions as those of the components described in the first embodiment are designated by the same reference numerals. Therefore, descriptions of those common components will not be repeated here.

A printer 31 according to the third embodiment is installed in a public institution including an airport, a hotel, a station, a convenience store, etc., or an office, for example. The printer 31 is connected to a Web server 35 via a network, such as the Internet 34. The user can use “copy service”, “medium-direct-print service”, “Web-print service”, and “FAX service” by using the printer 31.

The third embodiment is different from the first embodiment in that the operation unit 14 of the printer 31 includes a Web browser 32 and the printer 31 is connected to the Web server 35 via the internet 34, and the printer 31 has an operation-unit-and-Web-browser control unit 43 configured to transmit and/or receive information to/from the operation unit and the Web browser 32. The user can access a Web site on the Internet from the Web browser 32, download desired document data and/or image data to the HDD 19 of the printer 31, and print the downloaded data. The above-described service is referred to as “Web-print service”.

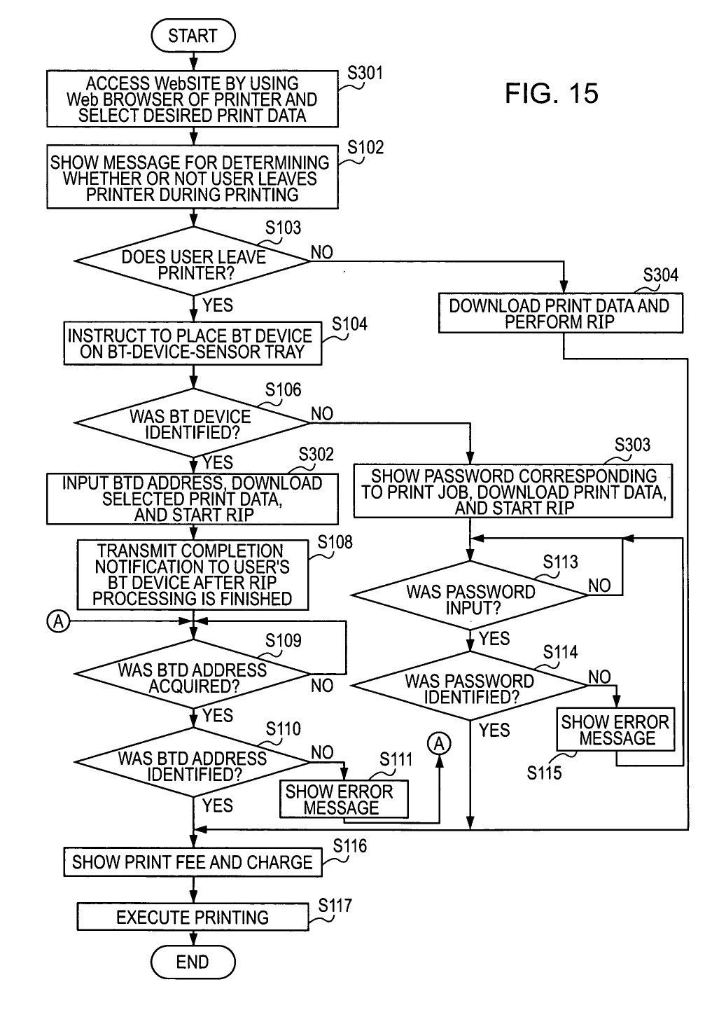

FIG. 15 shows the flow of processing performed by the printer 31 from when data is acquired from the Web site to when the data is printed. Steps S102, S103, and S104, step S106, steps S108, S109, S110, and S111, and steps S113, S114, S115, S116, and S117 shown in FIG. 15 will not be described below, since the above-described steps are the same as those described in the first embodiment or the second embodiment. Therefore, only steps S301, S302, S303, and S304 will be described below.

At step S301, the user comes to a convenience store or the like, so as to print document data existing on the Internet (a photograph released on a predetermined Web site by a friend of the user, a map, a coupon, a catalog, and so forth) by using the printer 31. Then, the user accesses a desired Web site from the operation unit 14 and the Web browser 32 and produces the image of a Web page which the user wishes to have printed. Then, the Web page or a file which the user wishes to have printed is selected and the number and resolution of prints are set. The Web page which the user wishes to have printed includes a catalog, a manual, photograph data, and so forth.

At step S302, when the user's BT device 7 placed on the BT-device-sensor tray 6 is identified, the screen image shown in FIG. 7 is displayed on the UI of the operation unit 14 and the BTD address unique to the user's BT device 7 is read.

Further, the main-control unit 12 can determine what kind of device the BT device 7 is, based on profile information stored in the device (BT-device identification-and-determination processing). If the BT device 7 is a PDA or a mobile phone that can receive a message based on the Bluetooth system, the main-control unit 12 makes the operation unit 14 display a message such as “You will be notified when print preparation is made” for the BT device 7 when the RIP is finished. Further, when the BT device 7 is headphones or a digital camera that cannot receive a message based on the Bluetooth system, a predetermined time period is required for performing the RIP. In that case, the main-control unit 12 shows a predetermined message on the operation unit 14, so as to instruct the user to wait for a while and come to the printer 1 again. After that, a display image shown on the operation unit 14 is changed, so as to show that the printer 1 is ready to start printing and receive a print instruction transmitted from the next user. Then, in the printer 31, the Web page or the file selected by the previous user is downloaded to the main-control unit 12 of the printer 31 and temporarily stored in the RAM 22 and/or the HDD 19. Then, the BTD address and the downloaded data are registered with the encryption-and-decryption print-management table 44 of the printer 31 in relation to each other and the rasterizing unit 24 performs RIP. For example, JOB_ID 0001 and JOB_ID 0002 that are shown in FIG. 2 correspond to a table generated when the BTD address is read. Further, while data is being downloaded and/or the RIP is being performed, the print settings made by the previous user are prevented from being changed by the next user, as long as the data is not identified by using the BTD address of the previous user.

At step S303, the printer 31 generates the secure-identification code corresponding to a print job selected by the user, at step S301, and the secure-identification code is shown on the operation unit 14, as shown in FIG. 10. Then, the selected Web page or file is-downloaded to the main-control unit 12 and temporarily stored in the RAM 22 and/or the HDD 19. The rasterizing unit 24 performs RIP for the selected print job. At that time, the secure-identification code is registered with the encryption-and-decryption print management table 44 in relation to the print job. Data that had been subjected to the RIP is encrypted by using the secure-identification code and stored in the HDD 19 and/or the RAM 22. Further, since the secure-identification code should be transmitted for performing printing, the user should remember the secure-identification code by writing it down, for example.

At step S304, the selected Web page or file is downloaded to the main-control unit 12 and the rasterizing unit 24 performs RIP for the downloaded print file.

Thus, the third embodiment allows preventing image data that had been subjected to RIP from being printed without performing identification, even though the user accesses a predetermined Web site and downloads desired image data and/or text data that the user wishes to have printed by using a printer including a Web browser. More specifically, image data that had been subjected to RIP is encrypted by using the secure-identification code corresponding to a print job and/or a BTD address unique to the BTD device 7 corresponding to the print job. Further, print-setting change and/or printing of the image data that had been subjected to the RIP is not permitted until identification is made by using the secure-identification code and/or the BTD address. As a result, it becomes possible to prevent the print data and/or the print settings from being changed by an outsider even though the user leaves the printer 31 while the RIP is being performed. Further, it becomes possible to prevent the image data that had been subjected to the RIP from being erroneously printed by a person other than the user who made a request to execute printing.

Further, since the user is informed that the RIP is finished via a communication device or system including a BT device, electronic mail, and so forth, not only the security of the print data can be retained but also the user can leave the printer 31 without fear of security problems. Subsequently, the user can make effective use of the print-waiting time.

Further, when the secure-identification code and/or the BTD address is registered with the printer 31, data is downloaded from the provider server 5 and RIP is started by the printer 31. Further, print-setting change and/or printing of the image data that had been subjected to the RIP is not permitted until identification is made by using the secure-identification code and/or the BTD address. Subsequently, it becomes possible to prevent the print data and/or the print settings from being changed by an outsider while desired data is downloaded from the provider server 5 and/or RIP is being performed. Therefore, the user can leave the printer 31 without fear of security problems.

### Other Embodiments

According to the above-described embodiments, the BT device 7 subjected to the identification is described, as a mobile phone. However, the BT device 7 may be provided, as an information apparatus or device including a PC, a digital camera, a digital video camera, head phones, a mini-disk (MD) recorder, a compact disk (CD) recorder, and so forth, as long as the BT device 7 includes a Bluetooth I/F.

Further, the printer described in each of the embodiments may be formed, as a multifunction apparatus that can function, as a fax machine, a copier, a scanner, a printer, and so forth.

Further, according to the above-described embodiments, the BT device 7 is identified by using the BTD address thereof. However, the BT device 7 may be identified by using radio frequency identification (RFID), an integrated circuit (IC) card, a wireless LAN, fingerprint information, and so forth.

Further, according to each of the above-described embodiments, the printer is installed in a public institution such as a convenience store. However, the printer may be installed in other places including an office, a house, etc.

Further, the object of the present invention can also be achieved, as described below. Namely, a computer (CPU, micro-processing unit (MPU), etc.) of a system or an apparatus reads and executes program code (software) adapted to implement the functions of the above-described embodiments, where the program code is stored in a storage medium.

In that case, the program code itself, read from the storage medium, achieves the functions of the above-described embodiments.

The storage medium for providing the program code may be, for example, a floppy disk, a hard disk, an optical disk, a magneto-optical disk, a CD-ROM, a CD-recordable (CD-R), a digital versatile disk-ROM (DVD-ROM), a DVD-R, a magnetic tape, a non-volatile memory card, etc. Further, the storage medium may be various recording mediums including a ROM, storage of a file server on a network, storage of a file transfer protocol (FTP) server on the Internet, and so forth.

Furthermore, not only by the computer reading and executing the program code, but also by the computer executing part of or the entire process utilizing an operating system (OS), etc. running on the computer based on instructions of the program code, the functions of the above-described embodiments may be achieved. The latter is also one of embodiments of the present invention.

The present invention is not limited to the above-described embodiments, but can be modified (an organic combination of the above-described embodiments is also considered to be modification) within the spirit of the present invention. The modification result is included within the scope of the present invention.

Thus, the present invention has been described with reference to the above-described embodiments. For one skilled in the art, however, the spirit and scope of the present invention are not limited to specific description disclosed in the specification of the present invention.

The scope of the following claims is to be accorded the broadest interpretation so as to encompass all modifications, equivalent structures and functions.

This application claims the benefit of Japanese Application No. 2004-376367 filed on Dec. 27, 2004, which is hereby incorporated by reference herein in its entirety.

What is claimed is:

1. An image-processing apparatus comprising:
an input unit configured to input print data;
a generation unit configured to generate image data from the print data;
a storage unit configured to store the image data in storage;
a notification unit configured to perform notification about an image-data-generation state of the generation unit;
an identification input unit configured to input identification information; and
an output unit configured to output the stored image data based on the identification information input via the identification input unit.

2. The image-processing apparatus according to claim 1, wherein the image data is encrypted and stored in the storage.

3. The image-processing apparatus according to claim 1, wherein the identification information is a Bluetooth-device address of an information device.

4. The image-processing apparatus according to claim 1, wherein a message is shown, so as to confirm whether a user leaves the image-processing apparatus.

5. The image-processing apparatus according to claim 1, wherein the image-data-generation state is a state where raster-image processing performed for the print data is finished.

6. The image-processing apparatus according to claim 1, wherein the notification is performed by using Bluetooth and/or electronic mail.

7. An image-processing method comprising steps of:
generating image data from print data;
storing the image data in storage;
performing notification about an image-data-generation status during the image data is generated;
obtaining identification information; and
outputting the stored image data based on identification information obtained.

8. The image-processing method according to claim 7, wherein the image data stored in the storage is encrypted.

9. The image-processing method according to claim 7, wherein the identification information is a Bluetooth-device address of an information device.

10. The image-processing method according to claim 7, further comprising steps of:
displaying a message requesting input as to whether or not a user leaves an image-processing apparatus configured to execute the image-processing method; and
accepting an input from the user in response to the message displayed confirming whether the user leaves the image-processing apparatus configured to execute the image-processing method.

11. The image-processing method according to claim 7, wherein the image-data-generation state is a state where raster-image processing performed for the print data is finished.

12. The image-processing method according to claim 7, wherein the notification is performed by using Bluetooth and/or electronic mail.

13. A program configured to make a computer execute:
generation code so that image data is generated from print data;
storing code so that the image data is stored in storage;
notification code, so as to perform notification about an image-data-generation state during the generation code is performed;
identification obtaining code so that identification information is obtained; and
output code so that the stored image data is output based on identification information obtained.
